(19) United States
(12) Patent Application Publication
(10) Pub. No.: US 2009/0029338 A1
(43) Pub. Date: Jan. 29, 2009

(54) DISPLAY BOARD ASSEMBLY

(75) Inventor: Seesong Kang, Northbrook, IL (US)

Correspondence Address: MICHAEL BEST & FRIEDRICH LLP, 100 EAST WISCONSIN AVENUE, SUITE 3300, MILWAUKEE, WI, 53202, US

(73) Assignee: ACCO Brands USA LLC, Lincolnshire, IL (US)

(21) Appl. No.: 12/178,026

(22) Filed: Jul. 23, 2008

Related U.S. Application Data
(60) Provisional application No. 60/951,537, filed on Jul. 24, 2007.

(51) Int. Cl. G09B 29/00

(52) U.S. Cl. 434/430

(57) ABSTRACT

A display board assembly includes a substrate having a first edge and a second edge, and a non-fabric bulletin board sheet including a first edge portion wrapped around the first edge of the substrate to at least partially cover the first edge of the substrate and a second edge portion wrapped around the second edge of the substrate to at least partially cover the second edge of the substrate.

### RELATED APPLICATIONS

This application claims priority to U.S. Provisional Patent Application Ser. No. 60/951,537 filed on Jul. 24, 2007, the entire content of which is incorporated herein by reference.

### FIELD OF THE INVENTION

The present invention relates to display board assemblies.

### BACKGROUND OF THE INVENTION

Dry-erase boards and bulletin boards are two examples of popular display boards. Dry-erase boards typically include a substrate or backing, a metal sheet having a dry-erase surface covering the backing, and a frame member on each side of the backing and the metal sheet to secure the metal sheet to the backing. Other conventional dry-erase boards are “frameless,” i.e., portions of the metal sheet having the dry-erase surface are wrapped or folded over each side of the backing to secure the metal sheet to the backing. Bulletin boards typically include a substrate or backing, a push-pin receiving layer (e.g., cork, foam, rubber, fabric, etc.) covering the backing, and a frame member on each side of the backing and the push-pin receiving layer to secure the push-pin receiving layer to the backing. The push-pin receiving layer is typically die-cut to correspond in size to the backing.

### SUMMARY OF THE INVENTION

The present invention provides, in one aspect, a display board assembly including a substrate having a first edge and a second edge, and a non-fabric bulletin board sheet including a first edge portion wrapped around the first edge of the substrate to at least partially cover the first edge of the substrate and a second edge portion wrapped around the second edge of the substrate to at least partially cover the second edge of the substrate.

The present invention provides, in another aspect, a method of assembling a display board, the method including providing a substrate having a first edge and a second edge, overlying the substrate with a non-fabric bulletin board sheet, wrapping a first portion of the non-fabric bulletin board sheet around the first edge of the substrate, and wrapping a second portion of the non-fabric bulletin board sheet around the second edge of the substrate.

The present invention provides, in yet another aspect, a display board assembly including a substrate defining a first dimension and a second dimension substantially transverse to the first dimension, the substrate having a first edge and a second edge in the direction of the first dimension and a third edge and a fourth edge in the direction of the second dimension. The display board assembly also includes at least one of a dry-erase sheet and a bulletin board sheet, the at least one of the dry-erase sheet and bulletin board sheet including a first edge portion wrapped around the first edge of the substrate to at least partially cover the substrate, and a second edge portion wrapped around the second edge of the substrate to at least partially cover the substrate. The display board assembly further includes a first frame member positioned over the third edge of the substrate to at least partially secure the one of the dry-erase sheet and bulletin board sheet to the substrate and a second frame member positioned over the fourth edge of the substrate to at least partially secure the one of the dry-erase sheet and the bulletin board sheet to the substrate.

The present invention provides, in a further aspect, a display board assembly including at least one substrate having a first surface and a second surface substantially parallel to the first surface, one of a dry-erase sheet and a bulletin board sheet overlying the first surface of the substrate, at least two frame members coupled to the substrate and the one of the dry-erase sheet and bulletin board sheet to secure the one of the dry-erase sheet and bulletin board sheet to the substrate, and recycling instructions printed on the second surface of the substrate.

The present invention provides, in another aspect, a display board assembly including at least one substrate having a first edge and a second edge, a first cutout adjacent the first edge, and a second cutout adjacent the second edge. The display board assembly also includes one of a dry-erase sheet and a bulletin board sheet overlying the substrate, a first frame member positioned over the first edge of the substrate and a portion of the one of the dry-erase sheet and bulletin board sheet, the first frame member having a tab engaging the first cutout, and a second frame member positioned over the second edge of the substrate and a portion of the one of the dry-erase sheet and bulletin board sheet, the second frame member having a tab engaging the second cutout.

The present invention provides, in yet another aspect, a method of disassembling a display board assembly for recycling. The display board assembly includes a substrate having a substantially flat surface, one of a dry-erase sheet and a bulletin board sheet covering the substrate, a first frame member positioned over a first edge of the substrate securing the one of the dry-erase sheet and bulletin board sheet to the substrate, and a second frame member positioned over a second edge of the substrate securing the one of the dry-erase sheet and bulletin board sheet to the substrate. The method includes providing a first cutout in the substrate adjacent the first edge of the substrate, the first cutout receiving a tab of the first frame member, providing a second cutout in the substrate adjacent the second edge of the substrate, the second cutout receiving a tab of the second frame member, prying the tab of the first frame member out of the first cutout using a hand tool, prying the tab of the second frame member out of the second cutout using the hand tool, and removing the first and second frame members from over the respective first and second edges of the substrate to allow the one of the dry-erase sheet and bulletin board sheet to be separated from the substrate.

Other features and aspects of the invention will become apparent by consideration of the following detailed description and accompanying drawings.

### BRIEF DESCRIPTION OF THE DRAWINGS

FIG. 1 is a front perspective view of a first construction of a display board assembly of the present invention.

FIG. 2 is a rear perspective view of the display board assembly of FIG. 1.

FIG. 3 is an exploded, rear perspective view of the display board assembly of FIG. 1.

FIG. 4 is a front perspective view of another construction of a display board assembly of the present invention.

FIG. 5 is a rear perspective view of the display board assembly of FIG. 4.

FIG. 6 is an exploded, rear perspective view of the display board assembly of FIG. 4.

FIG. 7 is a front perspective view of yet another construction of a display board assembly of the present invention.

FIG. 8 is a rear perspective view of the display board assembly of FIG. 7.

FIG. 9 is an exploded, rear perspective view of the display board assembly of FIG. 7.

FIG. 10 is a front perspective view of another construction of a display board assembly of the present invention.

FIG. 11 is a rear perspective view of the display board assembly of FIG. 10.

FIG. 12 is an exploded, rear perspective view of the display board assembly of FIG. 10.

FIG. 13 is a front perspective view of yet another construction of a display board assembly of the present invention.

FIG. 14 is a rear perspective view of the display board assembly of FIG. 13.

FIG. 15 is an exploded, rear perspective view of the display board assembly of FIG. 13.

FIG. 16 is a front perspective view of another construction of a display board assembly of the present invention.

FIG. 17 is a rear perspective view of the display board assembly of FIG. 16.

FIG. 18 is an exploded, rear perspective view of the display board assembly of FIG. 16.

FIG. 19 is a front perspective view of yet another construction of a display board assembly of the present invention.

FIG. 20 is a rear perspective view of the display board assembly of FIG. 19.

FIG. 21 is an exploded, rear perspective view of the display board assembly of FIG. 19.

FIG. 22 is a front perspective view of another construction of a display board assembly of the present invention.

FIG. 23 is a rear perspective view of the display board assembly of FIG. 22.

FIG. 24 is an exploded, rear perspective view of the display board assembly of FIG. 22.

FIG. 25 is a front perspective view of yet another construction of a display board assembly of the present invention.

FIG. 26 is a rear perspective view of the display board assembly of FIG. 25.

FIG. 27 is an exploded, rear perspective view of the display board assembly of FIG. 25.

FIG. 28 is a front perspective view of another construction of a display board assembly of the present invention.

FIG. 29 is a rear perspective view of the display board assembly of FIG. 28.

FIG. 30 is an exploded, rear perspective view of the display board assembly of FIG. 28.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

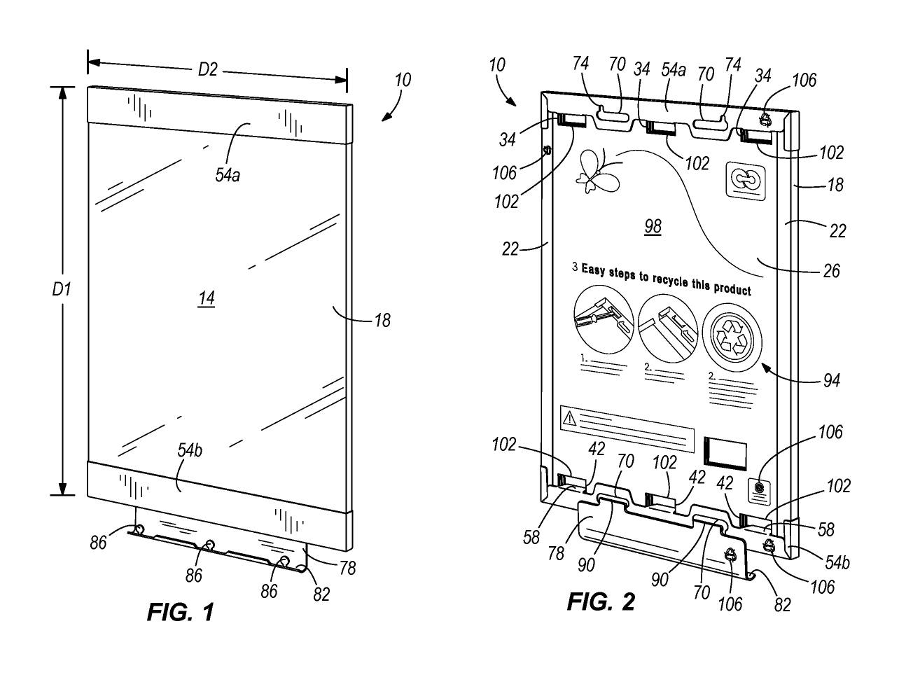

FIGS. 1-3 illustrate a first construction of a display board assembly 10 configured as a dry-erase board. The illustrated display board assembly 10 is rectangular-shaped, and therefore defines a major dimension D1 and a minor dimension D2. However, alternative constructions of the display board assembly 10 may have any of a number of different shapes (e.g., circular, oval, square, and so forth). As shown in FIG. 1, the display board assembly 10 is oriented such that its minor dimension D2 is substantially horizontal with respect to the ground, such that users of the display board assembly 10 may write along the minor dimension D2 of the display board assembly 10. Alternatively, the display board assembly 10 may be configured or oriented such that its major dimension D1 is substantially horizontal with respect to the ground, such that users of the display board assembly 10 may write along the major dimension D1 of the display board assembly 10.

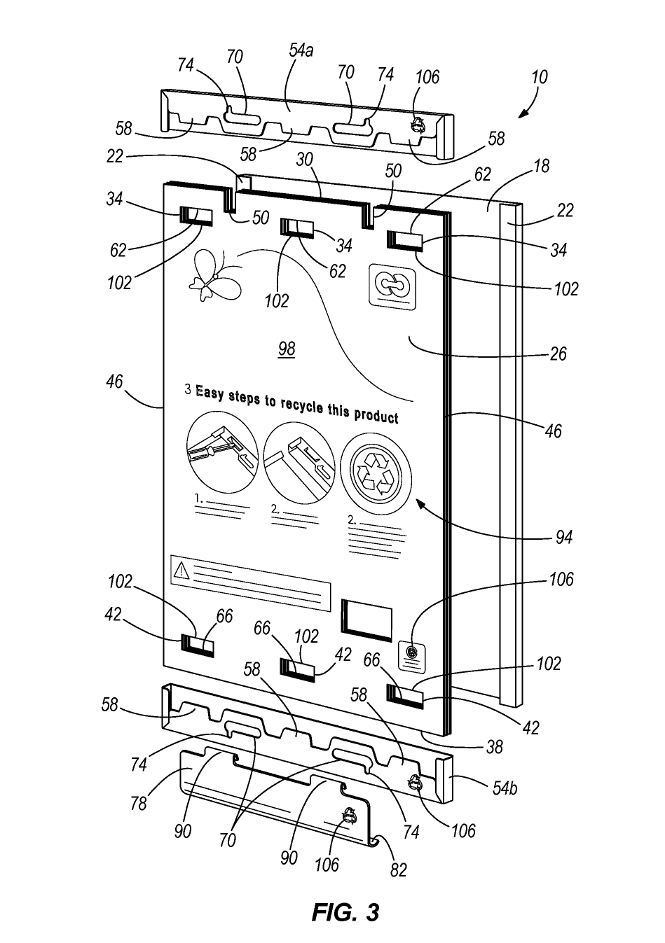

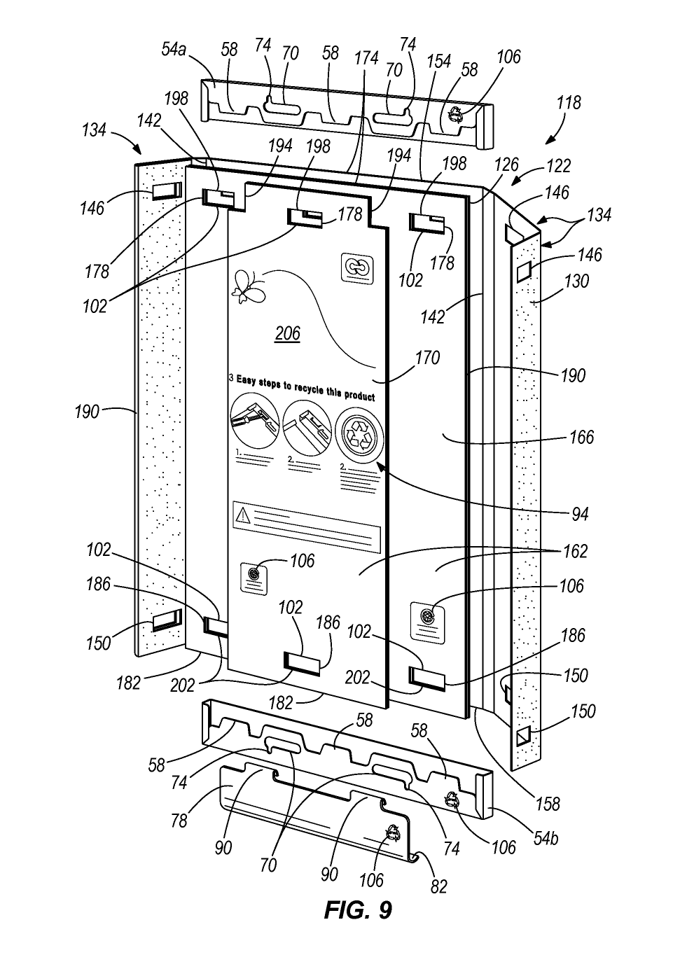

With continued reference to FIG. 1, the display board assembly 10 includes a dry-erase surface 14 for use with dry-erase markers. In the illustrated construction of the display board assembly 10, the dry-erase surface 14 is applied to a metallic outer shell 18 formed by a drawing, stamping, or other suitable forming process, which yields multiple edge portions 22 on the outer shell 18 (see FIGS. 2 and 3). Because the dry-erase surface 14 extends over the entire outer shell 18, the edge portions 22 of the outer shell 18, including the sides of the display board assembly 10, are usable as writing surfaces. The outer shell 18 or dry-erase sheet may be made from any of a number of different metals (e.g., tin, steel, etc.) capable of being formed to the desired configuration. Also, the outer shell 18 in the illustrated display board assembly 10 is made from a magnetic material (e.g., tin, steel, etc.), such that one or more magnets may be magnetically attached to the dry-erase surface 14 to secure paper documents, notes, or other items to the display board assembly 10. Alternatively, the outer shell 18 or dry-erase sheet may be made from a non-metallic material (e.g., a laminate including a corrugate board and a dry-erase coating or layer applied to the board). Such a dry-erase sheet may also include edge portions, similar to the edge portions 134 discussed below and shown in FIGS. 8 and 9, configured to at least partially wrap around an edge of a substrate or backing behind the dry-erase sheet to provide a “finished surface” on that side or edge of the display board assembly.

The dry-erase surface 14 may be applied to the outer shell 18 in any of a number of different ways. For example, the dry-erase surface 14 may be applied to the outer shell 18 as a substantially clear coating, so that the color of the underlying metal of the outer shell 18 (e.g., silver) is visible. The dry-erase surface 14 may also be applied to the outer shell 18 using a dry-erase paint on the outer shell 18, such that the color of the underlying metal of the outer shell 18 is covered by a coating of dry-erase paint of a different color (e.g., white). Further, the outer shell 18 may be covered by a conventional paint coating, which is overlaid by a substantially clear dry-erase coating. The dry-erase surface 14 may be applied to the outer shell 18 either before or after the outer shell 18 is formed into its final shape.

With reference to FIGS. 2 and 3, the display board assembly 10 includes a substrate or backing 26 behind the outer shell 18. In the illustrated construction of the display board assembly 10, the backing 26 includes a single corrugate board (e.g., Kraft® 51-pound ETC-AA corrugate board). Alternatively, the backing 26 may include two or more layers of corrugate or other paper-based boards, or can be made from other suitable backing materials (e.g., foam). With reference to FIG. 3, the backing 26 includes a top edge 30, a plurality of rectangular cutouts 34 positioned adjacent the top edge 30 of the backing 26, a bottom edge 38, a plurality of rectangular cutouts 42 positioned adjacent the bottom edge 38 of the backing 26, and substantially parallel side edges 46 that interconnect the top edge 30 and bottom edge 38. In the illustrated construction of the display board assembly 10, there are three cutouts 34, 42 positioned adjacent each of the top and bottom edges 30, 38 of the backing 26, and they are evenly distributed across the minor dimension D2 of the display board assembly 10. Alternatively, the backing 26 may be configured with more or fewer than three cutouts 34, 42 positioned adjacent each of the top and bottom edges 30, 38 of the backing 26. Also, in the illustrated construction of the display board assembly 10, the cutouts 34, 42 are oriented such that the respective length dimensions of the cutouts 34, 42 are oriented in a direction parallel to the minor dimension D2 of the display board assembly 10. As discussed in more detail below, the cutouts 34, 42 are utilized in assembling the display board assembly 10, and may alternatively be configured in any of a number of different shapes.

With continued reference to FIG. 3, additional cutouts 50 are positioned adjacent the top edge 30 of the backing 26 and are evenly distributed across the minor dimension D2 of the display board assembly 10. In the illustrated construction of the display board assembly 10, the cutouts 50 are oriented such that the respective length dimensions of the cutouts 50 are oriented in a direction parallel to the major dimension D1 of the display board assembly 10. As discussed in more detail below, the cutouts 50 are utilized in mounting the display board assembly 10, and may alternatively be configured in any of a number of different shapes.

With reference to FIGS. 2 and 3, the edge portions 22 on each side of the outer shell 18 are wrapped of folded to at least partially cover or overlie the respective side edges 46 of the backing 26. As such, the edge portions 22 at least partially secure the outer shell 18 to the backing 26, and present a “finished edge” on the sides of the display board assembly 10 to provide a partial frameless appearance to the display board assembly 10. The folding of the edge portions 22 of the outer shell 18 also substantially reduces or eliminates warping or bowing of the outer shell 18.

With continued reference to FIGS. 2 and 3, the display board assembly 10 also includes respective substantially identical frame members 54a, 54b positioned over the top and bottom edges 30, 38 of the backing 26, respectively, and at least partially over the edge portions 22 on each side of the outer shell 18. As such, the frame members 54a, 54b further secure the outer shell 18 to the backing 26, with no additional frame members interconnecting the frame members 54a, 54b. The frame members 54a, 54b may be made from the same metal as the outer shell 18 (e.g., tin, steel, etc.). Alternatively, the frame members 54a, 54b may be made from any of a number of different materials (e.g., plastic).

As shown in FIG. 3, each of the frame members 54a, 54b includes a plurality of tabs 58 spaced across the length of each frame member 54a, 54b to correspond with the number and position of the cutouts 34, 42 adjacent the top and bottom edges 30, 38 of the backing 26. During assembly of the top frame member 54a onto the outer shell 18 and backing 26, each of the tabs 58 is bent inwardly into its respective cutout 34 to engage a top side 62 of the cutout 34, thereby substantially preventing removal of the top frame member 54a from the outer shell 18 and backing 26. Likewise, during assembly of the bottom frame member 54b onto the outer shell 18 and backing 26, each of the tabs 58 is bent inwardly into its respective cutout 42 to engage a bottom side 66 of the cutout 42 (see FIG. 2), thereby substantially preventing removal of the bottom frame member 54b from the outer shell 18 and backing 26.

With reference to FIG. 3, each of the frame members 54a, 54b also includes two slots 70 evenly distributed across the minor dimension D2 of the display board assembly 10 and oriented such that the respective length dimensions of the slots 70 are oriented in a direction parallel to the minor dimension D2 of the display board assembly 10. Also, in the illustrated construction of the display board assembly 10, the slots 70 are positioned between the tabs 58 on the frame members 54a, 54b, and the slots 70 in the top frame member 54a at least partially overlie or coincide with the cutouts 50 in the backing 26. Each of the frame members 54a, 54b also includes respective notches 74 extending from the slots 70 in a direction substantially transverse to the respective length dimensions of the slots 70. Particularly, the notches 74 in the top frame member 54a at least partially overlie or coincide with the cutouts 50 in the backing 26. The combination of the slots 70 and notches 74 in the top frame member 54a and the cutouts 50 in the backing 26 facilitate mounting of the display board assembly 10 on a substantially vertical surface (e.g., a wall) in a conventional manner (e.g., using nails, screws, or other hanging members).

With reference to FIGS. 1-3, the display board assembly 10 may also include a tray 78 coupled to the bottom frame member 54b. The tray 78 includes a surface 82 configured to support writing utensils (e.g., dry-erase markers) and other utensils (e.g., erasers). As shown in FIG. 1, the tray 78 also includes a plurality of hooks 86 extending from the support surface 82 and evenly distributed across the length of the tray 78. The hooks 86 may be configured to receive items such as key rings to support house keys, automobile keys, and the like. The tray 78 may be made from the same metal as the outer shell 18 and the frame members 54a, 54b (e.g., tin, steel, etc.). Alternatively, the tray 78 may be made from any of a number of different materials (e.g., plastic).

With reference to FIG. 3, the tray 78 includes two fingers 90 configured to be received within the slots 70 in the bottom frame member 54b to support the tray 78 from the bottom frame member 54b. The fingers 90 may be inserted within the slots 70 in the bottom frame member 54b during assembly of the bottom frame member 54b onto the outer shell 18 and backing 26 or afterwards. Alternatively, any of a number of different structural elements may be utilized to couple the tray 78 to the bottom frame member 54b.

The interconnection of the outer shell 18 to the backing 26 via the wrapped edge portions 22, and the interconnection of the frame members 54a, 54b to the outer shell 18 and the backing 26, all without the use of adhesives, fasteners, or other permanent means, facilitate the disassembly of the display board assembly 10 to allow each of the components of the display board assembly 10 to be recycled. With reference to FIGS. 2 and 3, instructions 94 for disassembling and recycling the display board assembly 10 are printed on an exposed surface 98 of the backing 26. To disassemble the display board assembly 10, as shown by the instructions 94, one would merely use a hand tool (e.g., a flat-head screwdriver) to pry the bent tabs 58 from engaging the respective sides 62, 66 of the cutouts 34, 42 and continue to pry the tabs 58 until they are displaced outside of the cutouts 34, 42. The corners 102 of the cutouts 34, 42 may be utilized as a fulcrum to provide a mechanical advantage in prying the tabs 58 out of the cutouts 34, 42. The cutouts 34, 42 and tabs 58 may be configured in any of a number of different shapes that would allow a similar process for assembly and disassembly of the display board assembly 10.

After the tabs 58 are displaced outside of the cutouts 34, 42, the frame members 54a, 54b may be removed from the outer shell 18 and the backing 26, and then the backing 26 can be removed from the outer shell 18 by sliding the backing 26 out of the outer shell 18. One would then recycle the individual components of the display board assembly 10—i.e., the backing 26 may be recycled with other corrugate board material, while the outer shell 18, frame members 54a, 54b, and the tray 78 may be recycled with other similar scrap metals. As shown in FIG. 2, the backing 26, outer shell 18, frame members 54a, 54b, and the tray 78 each include a marking 106 indicating that the material comprising the backing 26, outer shell 18, frame members 54a, 54b, and the tray 78 may be recycled.

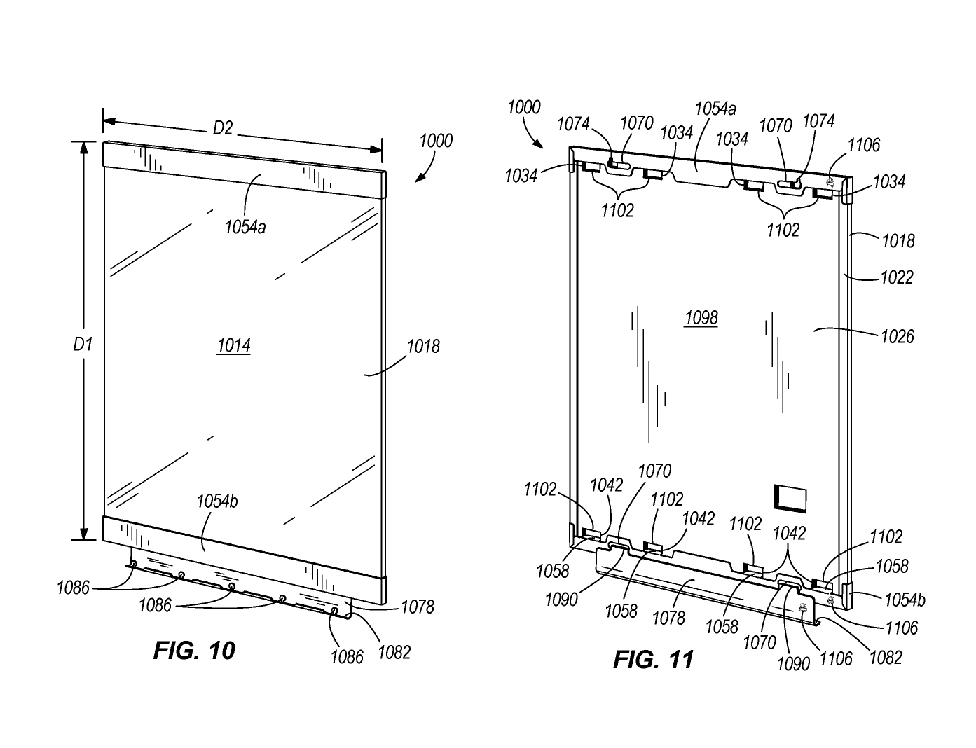

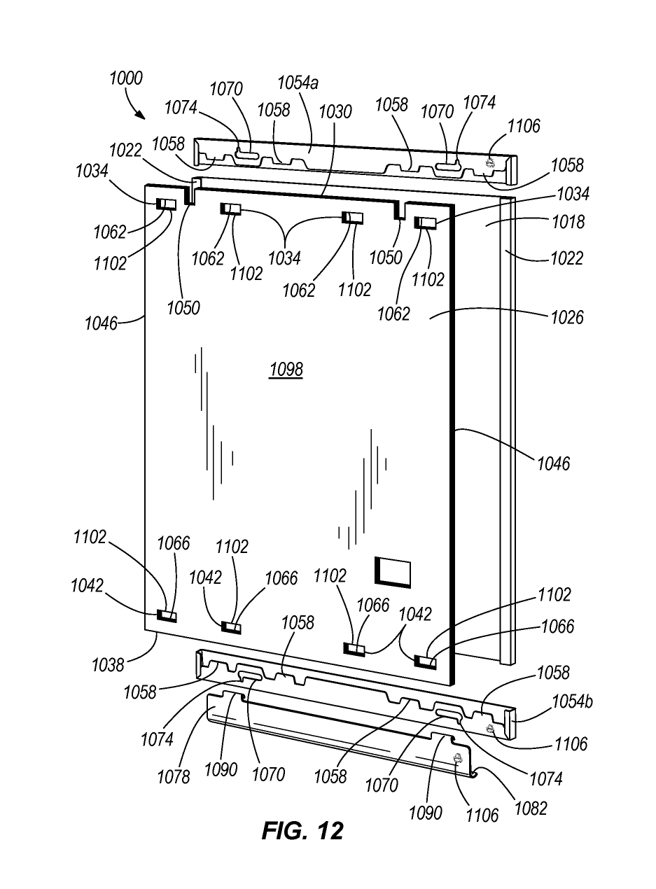

FIGS. 10-12 illustrate another construction of a display board assembly 1000 configured as a dry-erase board. The display board assembly 1000 of FIGS. 10-12 is substantially similar to the display board assembly 10 of FIGS. 1-3. Like components are labeled with like reference numerals, plus “1000.” However, the display board assembly 1000 includes a minor dimension D2 greater than that of the display board assembly 10 of FIGS. 1-3. As a result, the top and bottom frame members 1054a, 1054b are longer than the frame members 54a, 54b of the display board assembly 10 of FIGS. 1-3, and the top frame member 1054a includes four tabs 1058 configured to engage respective cutouts 1034 adjacent the top edge 1030 of the backing 1026, and the bottom frame member 1054b includes four tabs 1058 configured to engage respective cutouts 1042 adjacent the bottom edge 1038 of the backing 1026. The tray 1078 is also longer than the tray 78 of the display board assembly 10 of FIGS. 1-3, and is configured with five hooks 1086. Alternatively, the tray 1078 may be configured with more or less than five hooks 1086.

The display board assembly 1000 may be disassembled in the same manner as described above with reference to the display board assembly 10 to allow each of the components of the display board assembly 1000 to be recycled. Although recycling instructions are not shown on the rear of the display board assembly 1000, recycling instructions similar to the instructions 94 on the display board assembly 10 of FIGS. 1-3 may also be incorporated on the rear of the display board assembly of FIGS. 10-12.

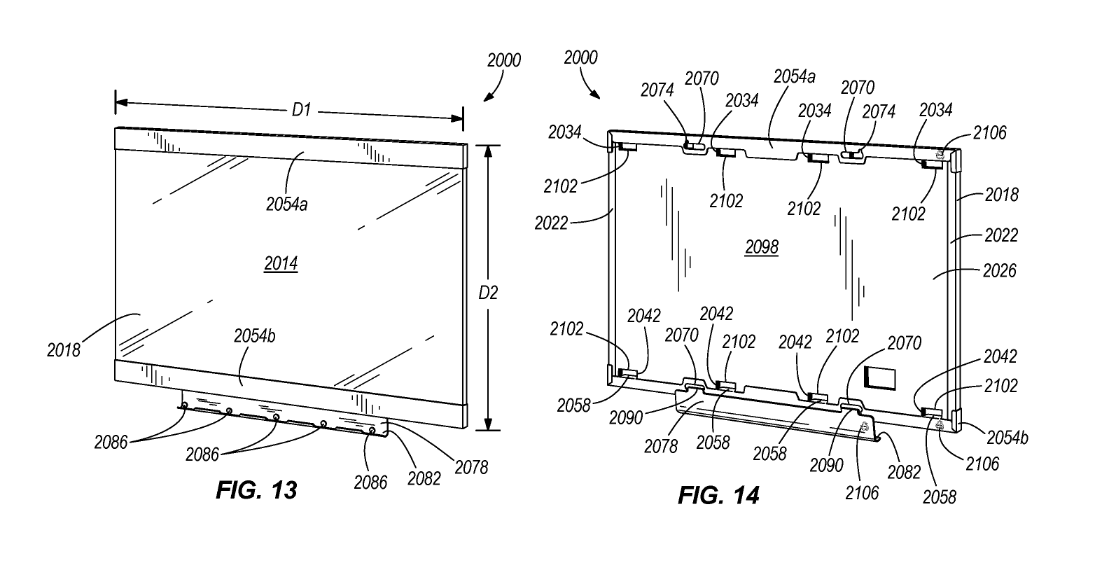

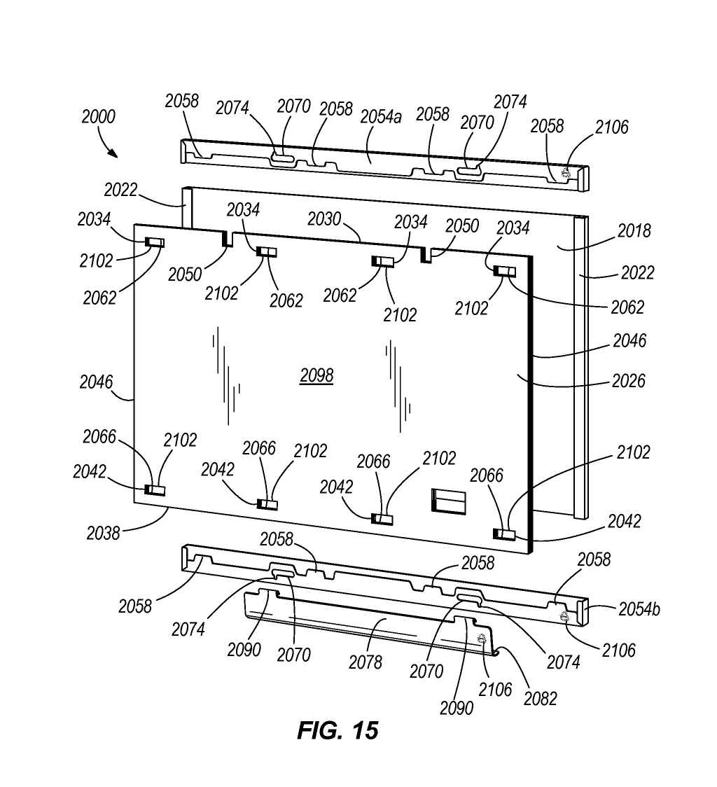

FIGS. 13-15 illustrate yet another construction of a display board assembly 2000 configured as a dry-erase board. With the exception that the display board assembly 2000 is configured in a landscape orientation (i.e., users of the display board assembly 2000 may write along the major dimension D1 of the display board assembly 2000), the display board assembly 2000 of FIGS. 13-15 is substantially similar to the display board assembly 10 of FIGS. 1-3. Like components are labeled with like reference numerals, plus “2000.” Like the display board assembly 1000 of FIGS. 10-12, the display board assembly 2000 includes top and bottom frame members 2054a, 2054b that are longer than the frame members 54a, 54b of the display board assembly 10 of FIGS. 1-3, and the top frame member 2054a includes four tabs 2058 configured to engage respective cutouts 2034 adjacent the top edge 2030 of the backing 2026, and the bottom frame member 2054b includes four tabs 2058 configured to engage respective cutouts 2042 adjacent the bottom edge 2038 of the backing 2026. The tray 2078 is also longer than the tray 78 of the display board assembly 10 of FIGS. 1-3, and is configured with five hooks 2086. Alternatively, the tray 2078 may be configured with more or less than five hooks 2086.

The display board assembly 2000 may be disassembled in the same manner as described above with reference to the display board assembly 10 to allow each of the components of the display board assembly 2000 to be recycled. Although recycling instructions are not shown on the rear of the display board assembly 2000, recycling instructions similar to the instructions 94 on the display board assembly 10 of FIGS. 1-3 may also be incorporated on the rear of the display board assembly 2000 of FIGS. 13-15.

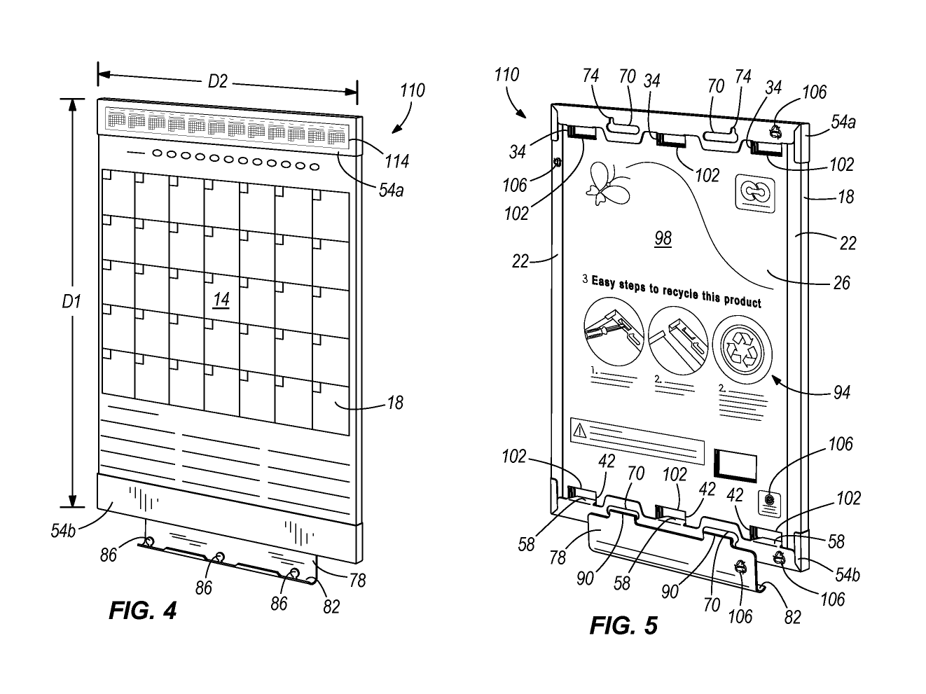

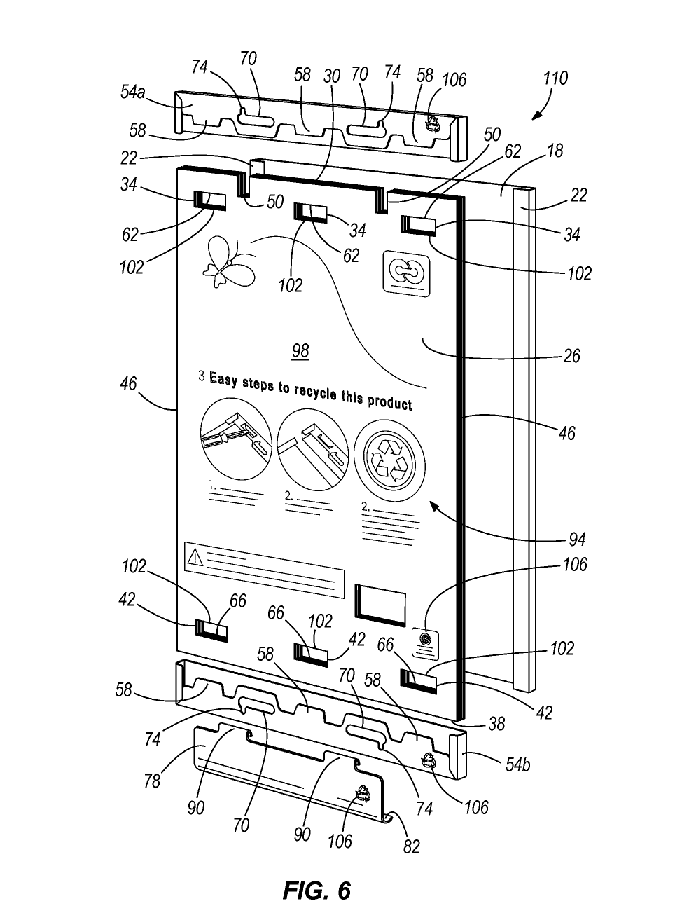

FIGS. 4-6 illustrate another construction of a display board assembly 110 configured as a dry-erase board. The display board assembly 110 of FIGS. 4-6 is substantially similar to the display board assembly 10 of FIGS. 1-3. Like components are labeled with like reference numerals. The display board assembly 110 of FIGS. 4-6 includes a calendar printed on the dry-erase surface 14 of the display board assembly 110 to facilitate usage of the display board assembly 110 as a scheduler or planner. The display board assembly 110 may also include one or more magnetic strips 114 magnetically attached to one of the frame members 54a, 54b, each of the strips 114 having all of the months for a particular calendar year printed thereon. Users of the display board assembly 110 may reference these strips 114 in adapting the calendar printed on the dry-erase surface 14 to display a particular month in a particular year. Upon the start of a new year, the prior year's strip 114 can be removed to expose the strip 114 for the new year. Although not shown, the display board assembly 1000 of FIGS. 10-12 may include a calendar printed on the dry-erase surface 1014 of the display board assembly 1000, in the same manner as the display board assembly 110 of FIGS. 4-6, to facilitate usage of the display board assembly 1000 as a scheduler or planner. The display board assembly 1000 of FIGS. 10-12 may also include the magnetic strips 114 shown in FIG. 4 and described above. Likewise, the display board assembly 2000 of FIGS. 13-15 may also include a calendar printed on the dry-erase surface 2014 of the display board assembly 2000, in the same manner as the display board assembly 110 of FIGS. 4-6, to facilitate usage of the display board assembly 2000 as a scheduler or planner. The display board assembly 2000 of FIGS. 13-15 may also include the magnetic strips 114 shown in FIG. 4 and described above.

Because the display board assembly 110 is assembled from the same components as the display board assembly 10 of FIGS. 1-3, the display board assembly may 110 be assembled and disassembled in the same way as described above with reference to the display board assembly 10 of FIGS. 1-3. Further, the components of the display board assembly 110 may be recycled in the same way as described above with reference to the display board assembly 10 of FIGS. 1-3.

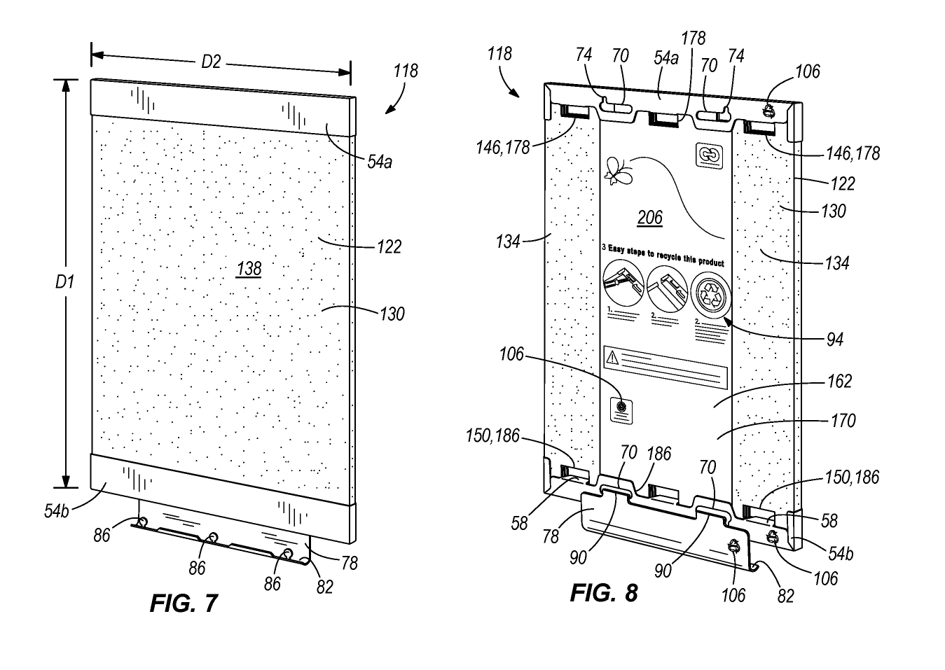

FIGS. 7-9 illustrate yet another construction of a display board assembly 118 configured as a bulletin board in the form of a cork board. Some of the components of the display board assembly 118—e.g., the frame members 54a, 54b and the tray 78—are substantially identical to those described above with reference to the display board assembly 10 of FIGS. 1-3. Like components are labeled with like reference numerals and will not be discussed again in detail. With reference to FIG. 9, the display board assembly 118 includes a laminate bulletin board sheet or an outer shell 122 comprised of a fluted corrugate board backing 126 (e.g., Kraft® 32-pound corrugate board with ETC-E flute) and a cork sheet 130 about 1 mm in thickness adhered (e.g., by gluing) to the corrugate board backing 126. Alternatively, the fluted corrugate board backing 126 and adhered cork sheet 130 may have any of a number of different weights or thicknesses. As a further alternative, the bulletin board sheet or outer shell 122 may be made from any of a number of different materials into which push-pins may be inserted (e.g., fabric, foam, rubber, etc.). The terms “bulletin board” or “bulletin board sheet” as used herein and in the appended claims contemplate the use of any materials into which push-pins may be inserted unless explicitly limited to the contrary. For example, the use of the term “non-fabric bulletin board sheet” means a bulletin board sheet that can be made from any suitable material except fabric.

With continued reference to FIG. 9, the outer shell 122 includes opposite edge portions 134 that are movable or foldable with respect to a bulletin board surface 138 of the outer shell 122 (see FIG. 7) due to the longitudinal fluting provided on the fluted corrugate board backing 126. As such, the fluting provides one or more fold lines 142 that extend in a direction substantially parallel to the major dimension D1 of the display board assembly 118 (see FIG. 9). As a result of the fluting in the corrugate board backing 126, folds in the cork sheet 130, which is otherwise resilient, may be maintained or sustained in the cork sheet 130 without directly attaching the cork sheet 130 to a frame or stretching the cork sheet 130 around a frame. The corrugate board backing 126 also allows push-pins to be inserted through the edge portions 134, particularly on the sides of the display board assembly 118. Also, in the illustrated construction of the outer shell 122, the edge portions 134 are each folded in upon themselves to increase the thickness of the edge portions 134 of the outer shell 122. Alternatively, the weight of the corrugate board backing 126 and the thickness of the cork sheet 130 may be increased to eliminate folding of the edge portions 134 upon themselves.

The outer shell 122 includes a plurality of cutouts 146, 150 positioned adjacent top and bottom edges 154, 158 of the outer shell 122, respectively. In the illustrated construction of the display board assembly 118, the cutouts 146, 150 are oriented such that the respective length dimensions of the cutouts 146, 150 are oriented in a direction parallel to the minor dimension D2 of the display board assembly 118. As discussed in more detail below, the cutouts 146, 150 are utilized in assembling the display board assembly 118, and may alternatively be configured in any of a number of different shapes.

With reference to FIG. 9, the display board assembly 118 includes a substrate or backing 162 beneath the outer shell 122. In the illustrated construction of the display board assembly 118, the backing 162 includes two corrugate boards 166, 170 made from the same material (e.g., Kraft® 44-pound ETC-C corrugate board) stacked upon one another. In some embodiments of the display board assembly 118, the corrugate boards 166, 170 may be adhered to each other (e.g., by gluing). Alternatively, the backing 162 may include one layer or more than two layers of corrugate or other paper-based boards. With continued reference to FIG. 9, the backing 162 includes a top edge 174, a plurality of rectangular cutouts 178 positioned adjacent the top edge 174 of the backing 162, a bottom edge 182, a plurality of rectangular cutouts 186 positioned adjacent the bottom edge 182 of the backing 162, and substantially parallel side edges 190 that interconnect the top edge 174 and the bottom edge 182. In the illustrated construction of the display board assembly 118, there are three cutouts 178, 186 positioned adjacent each of the top and bottom edges 174, 182 of the backing 162, and they are evenly distributed across the minor dimension D2 of the display board assembly 118. Alternatively, the backing 162 may be configured with more or fewer than three cutouts 178, 186 positioned adjacent each of the top and bottom edges 174, 182 of the backing 162. Also, in the illustrated construction of the display board assembly 118, the cutouts 178, 186 are oriented such that the respective length dimensions of the cutouts 178, 186 are oriented in a direction parallel to the minor dimension D2 of the display board assembly 118.

The backing 162 includes additional cutouts 194, formed in the outermost board 170, positioned adjacent the top edge 174 of the backing 162 and that are evenly distributed across the minor dimension D2 of the display board assembly 118. As discussed in more detail below, the cutouts 194 are utilized in mounting the display board assembly 118, and may alternatively be configured in any of a number of different shapes.

To assemble the display board assembly 118, the backing 162 is first overlaid onto the outer shell 122 such that the cutouts 178, 186 in the backing 162 and the cutouts 146, 150 in the middle portion of the outer shell 122 are aligned, and the fold lines 142 in the outer shell 122 are substantially parallel with the side edges 190 of the backing 162. Next, the edge portions 134 may be wrapped or folded over the respective side edges 190 of the backing 162 to at least partially cover the side edges 190 of the backing 162. As such, the edge portions 134 at least partially secure the outer shell 122 to the backing 162, and present a “finished edge” on the sides of the display board assembly 118 to provide a partial frameless appearance to the display board assembly 118. As shown in FIG. 8, the edge portions 134 substantially make-up the difference in thickness between the layered corrugate boards 166, 170, such that the edge portions 134 are substantially flush with the outermost board 170 of the backing 162. The folding of the edge portions 134 of the outer shell 122 also substantially reduces or eliminates warping or bowing of the outer shell 122, and particularly the cork sheet 130.

The frame members 54a, 54b are then positioned over the top and bottom edges 174, 182, respectively, of the backing 162 and the top and bottom edges 154, 158 of the outer shell 122 to further secure the outer shell 122 to the backing 162. During assembly of the top frame member 54a onto the outer shell 122 and backing 162, each of the tabs 58 is bent inwardly into its respective cutout 146, 178 to engage a top side 198 of the cutouts 146, 178, thereby substantially preventing removal of the top frame member 54a from the outer shell 122 and backing 162. Likewise, during assembly of the bottom frame member 54b onto the outer shell 122 and backing 162, each of the tabs 58 is bent inwardly into its respective cutout 150, 186 to engage a bottom side 202 of the cutouts 150, 186 (see FIG. 8), thereby substantially preventing removal of the bottom frame member 54b from the outer shell 122 and backing 162. Upon assembly of the top frame member 54a onto the outer shell 122 and backing 162, the notches 74 in the top frame member 54a at least partially overlie or coincide with the cutouts 194 in the backing 162. The combination of the slots 70 and notches 74 in the top frame member 54a and the cutouts 194 in the backing 162 facilitate mounting of the display board assembly 118 on a substantially vertical surface (e.g., a wall) in a conventional manner (e.g., using nails, screws, or other hanging members). The tray 78 may be coupled to the bottom frame member 54b in the same manner as discussed above with reference to the display board assembly 10 of FIGS. 1-3.

The interconnection of the outer shell 122 to the backing 162 via the wrapped edge portions 134, and the interconnection of the frame members 54a, 54b to the outer shell 122 and backing 162, all without the use of adhesives, fasteners, or other permanent means, facilitate the disassembly of the display board assembly 118 to allow each of the components of the display board assembly 118 to be recycled. With reference to FIGS. 8 and 9, instructions 94 for disassembling the display board assembly 118 are printed on an exposed surface 206 of the outermost board 170 of the backing 162. The display board assembly 118 of FIGS. 7-9 may be disassembled in a manner similar to the display board assembly 10 of FIGS. 1-3.

After the display board assembly 118 is broken down or disassembled, one would then recycle the individual components of the display board assembly 118—i.e., the backing 162 and outer shell 122 may be recycled with other corrugate board material, while the frame members 54a, 54b and the tray 78 may be recycled with other similar scrap metals. As shown in FIGS. 8 and 9, the backing 162, frame members 54a, 54b, and the tray 78 each include a marking 106 indicating that the material comprising the backing 162, frame members 54a, 54b, and the tray 78 may be recycled. Although not shown in FIGS. 7-9, the outer shell 122 may include a similar marking 106 to indicate that it may be recycled.

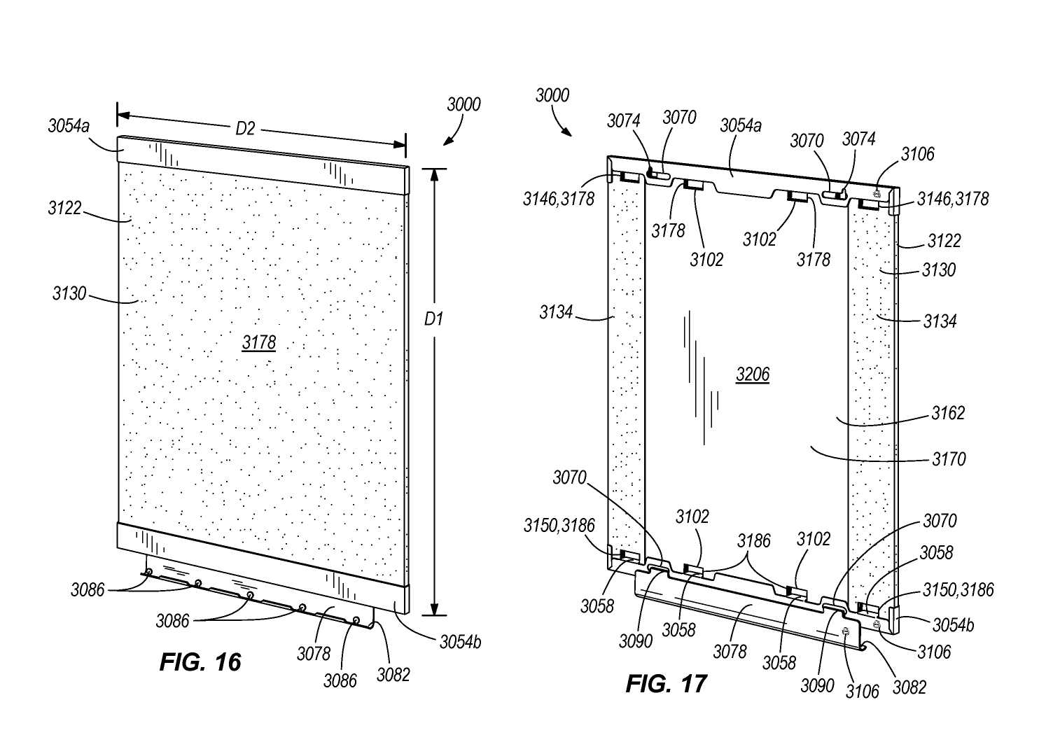

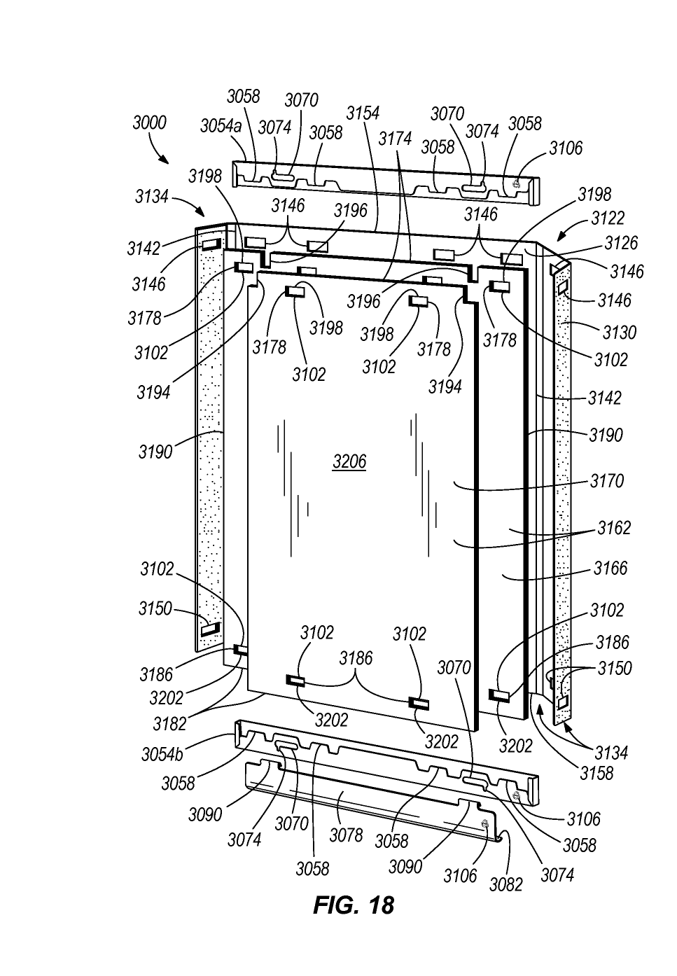

FIGS. 16-18 illustrate another construction of a display board assembly 3000 configured as a bulletin board. The display board assembly 3000 of FIGS. 16-18 is substantially similar to the display board assembly 118 of FIGS. 7-9. Like components are labeled with like reference numerals, plus “3000.” However, the display board assembly 3000 includes a minor dimension D2 greater than that of the display board assembly 118 of FIGS. 7-9. As a result, the top and bottom frame members 3054a, 3054b are longer than the frame members 54a, 54b of the display board assembly 118 of FIGS. 7-9, and the top frame member 3054a includes four tabs 3058 configured to engage respective cutouts 3178 adjacent the top edge 3174 of the backing 3162, and the bottom frame member 3054b includes four tabs 3058 configured to engage respective cutouts 3186 adjacent the bottom edge 3182 of the backing 3162. The tray 3078 is also longer than the tray 78 of the display board assembly 10 of FIGS. 1-3, and is configured with five hooks 3086. Alternatively, the tray 3078 may be configured with more or less than five hooks 3086. With reference to FIG. 18, the corrugate board 3166 includes cutouts 3196 that are substantially aligned with the cutouts 3194 in the corrugate board 3170 to facilitate mounting of the display board 3000.

The display board assembly 3000 may be disassembled in the same manner as described above with reference to the display board assembly 118 to allow each of the components of the display board assembly 3000 to be recycled. Although recycling instructions are not shown on the rear of the display board assembly 3000, recycling instructions similar to the instructions 94 on the display board assembly 118 of FIGS. 7-9 may also be incorporated on the rear of the display board assembly 3000 of FIGS. 16-18.

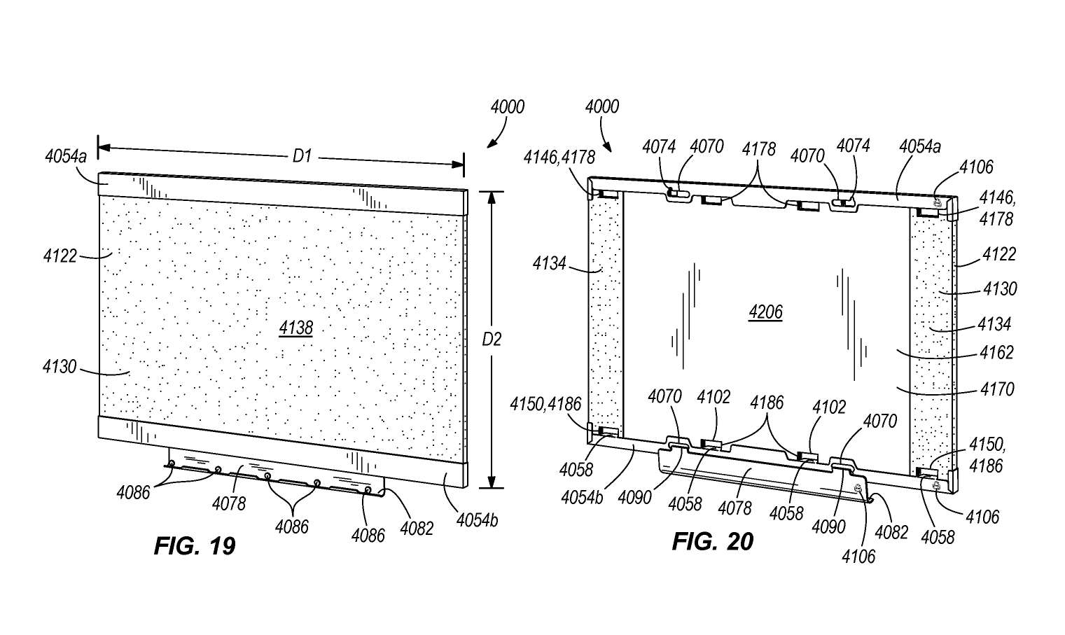

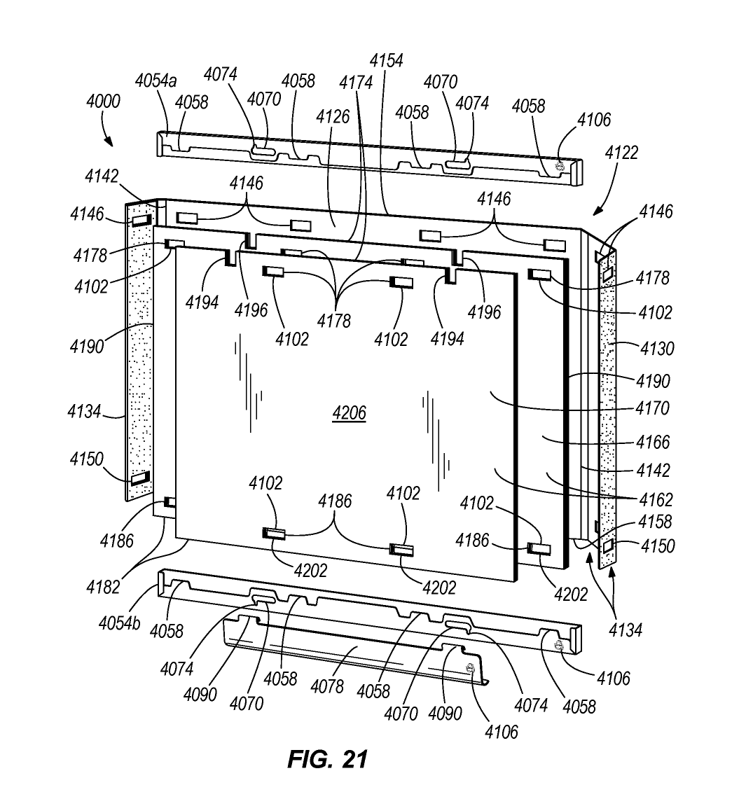

FIGS. 19-21 illustrate yet another construction of a display board assembly 4000 configured as a bulletin board. With the exception that the display board assembly 4000 is configured in a landscape orientation (i.e., the major dimension D1 of the display board assembly 4000 is oriented substantially horizontal with the ground), the display board assembly 4000 of FIGS. 19-21 is substantially similar to the display board assembly 118 of FIGS. 7-9. Like components are labeled with like reference numerals, plus “4000.” Like the display board assembly 3000 of FIGS. 16-18, the display board assembly 4000 includes top and bottom frame members 4054a, 4054b that are longer than the frame members 54a, 54b of the display board assembly 118 of FIGS. 7-9, and the top frame member 4054a includes four tabs 4058 configured to engage respective cutouts 4178 adjacent the top edge 4174 of the backing 4162, and the bottom frame member 4054b includes four tabs 4058 configured to engage respective cutouts 4186 adjacent the bottom edge 4182 of the backing 4162. With reference to FIG. 21, the corrugate board 4166 includes cutouts 4196 that are substantially aligned with the cutouts 4194 in the corrugate board 4170 to facilitate mounting of the display board 4000.

The display board assembly 4000 may be disassembled in the same manner as described above with reference to the display board assembly 118 to allow each of the components of the display board assembly 4000 to be recycled. Although recycling instructions are not shown on the rear of the display board assembly 4000, recycling instructions similar to the instructions 94 on the display board assembly 118 of FIGS. 7-9 may also be incorporated on the rear of the display board assembly 4000 of FIGS. 19-21.

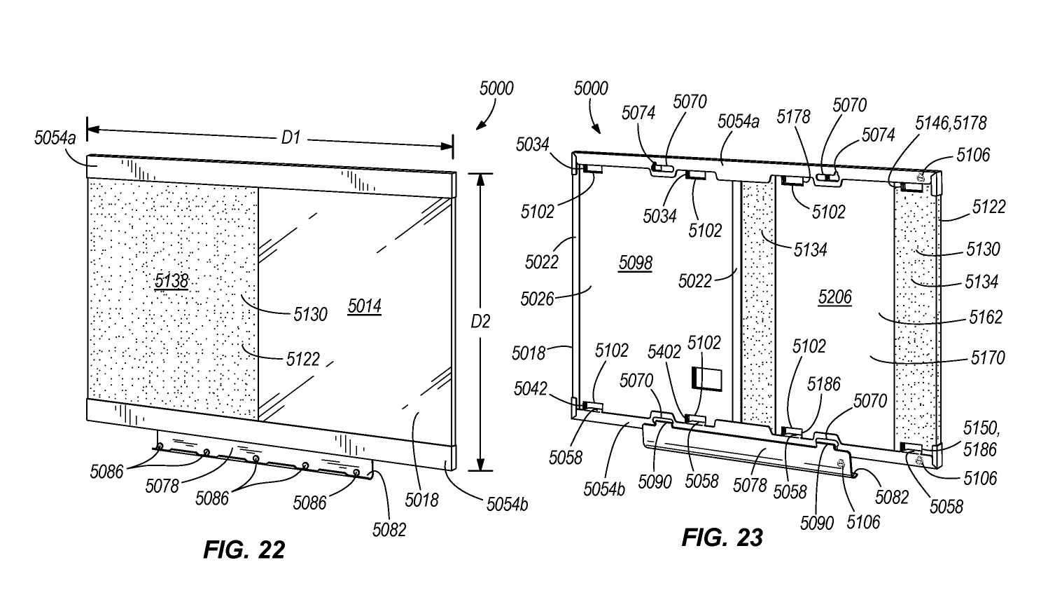

FIGS. 22-24 illustrate yet another construction of a display board assembly 5000 configured as a combination dry-erase board and bulletin board. The display board assembly 5000 includes components that are substantially similar to both of the display board assembly 10 of FIGS. 1-3 and the display board assembly 118 of FIGS. 7-9. Like components are labeled with like reference numerals, plus “5000.”

As shown in FIG. 22, the display board assembly 5000 is oriented such that its major dimension D1 is substantially horizontal with respect to the ground. As such, the abutting edge portions 5022, 5134 of the outer shells 5018, 5122 (see FIG. 23), respectively, define a substantially vertical separation line between the dry-erase surface 5014 on the outer shell 5018 and the bulletin board surface 5138 of the outer shell 5122 (see FIG. 22). As such, the outer shell 5018 and the outer shell 5122 are arranged in a side-by-side relationship. In the illustrated construction of the display board assembly 5000, about one-half of the value of the major dimension D1 of the display board assembly 5000 is comprised of the dry-erase surface 5014, and about one-half of the value of the major dimension D1 of the display board assembly 5000 is comprised of the bulletin board surface 5138. Alternatively, more or less than one-half of the value of the major dimension D1 of the display board assembly 5000 may be comprised of the dry-erase surface 5014, with the balance comprised of the bulletin board surface 5138.

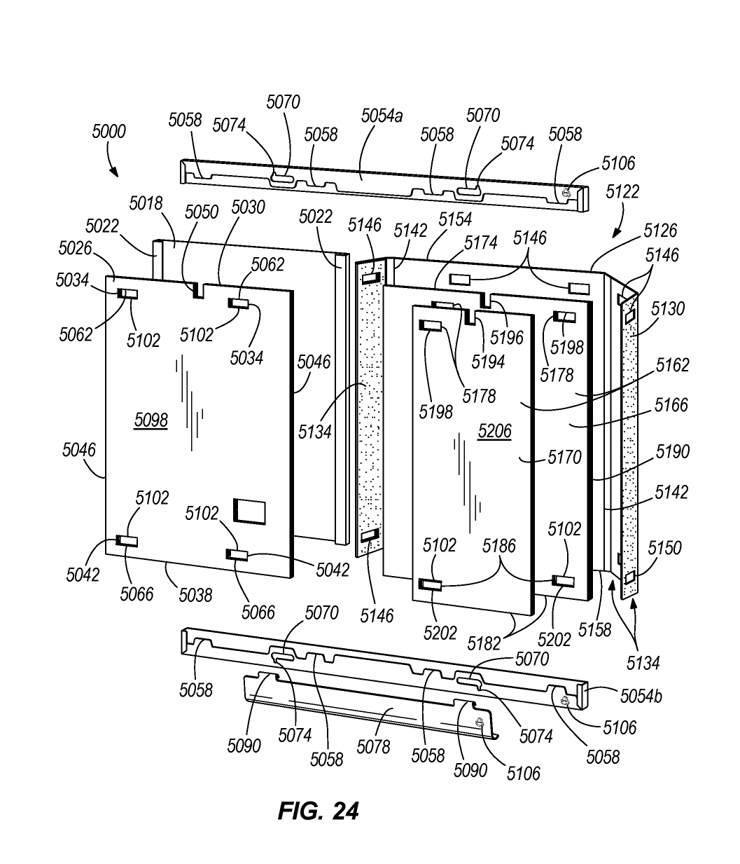

Because the display board assembly 5000 utilizes substantially similar frame members 5054a, 5054b as the display board assembly 2000 of FIGS. 13-15 and the display board assembly 4000 of FIGS. 19-21, the cutouts 5034 adjacent the top edge 5030 of the backing 5026 and the cutouts 5178 adjacent the top edge 5174 of the backing 5162 are spaced along the major dimension D1 of the display board assembly 5000 to receive the four tabs 5058 of the top frame member 5054a (see FIGS. 23 and 24). Likewise, the cutouts 5042 adjacent the bottom edge 5038 of the backing 5026 and the cutouts 5186 adjacent the bottom edge 5182 of the backing 5162 are spaced along the major dimension D1 of the display board assembly 5000 to receive the four tabs 5058 of the bottom frame member 5054b.

Also, because the display board assembly 5000 utilizes substantially similar frame members 5054a, 5054b as the display board assembly 2000 of FIGS. 13-15 and the display board assembly 4000 of FIGS. 19-21, the cutout 5050 positioned adjacent the top edge 5030 of the backing 5026 is substantially aligned with the notch 5074 in one of the slots 5070 in the top frame member 5054a, and the cutouts 5194, 5196 positioned adjacent the top edge 5174 of the backing 5162 are substantially aligned with the notch 5074 in the other of the slots 5070 in the top frame member 5054a to facilitate mounting of the display board assembly 5000.

The display board assembly 5000 may be disassembled in the same manner as described above with reference to the display board assembly 10 of FIGS. 1-3 and the display board assembly 118 of FIGS. 7-9 to allow each of the components of the display board assembly 5000 to be recycled. Although recycling instructions are not shown on the rear of the display board assembly 5000, recycling instructions similar to the instructions 94 on the display board assembly 10 of FIGS. 1-3 and the display board assembly 118 of FIGS. 7-9 may also be incorporated on the rear of the display board assembly 5000 of FIGS. 22-24.

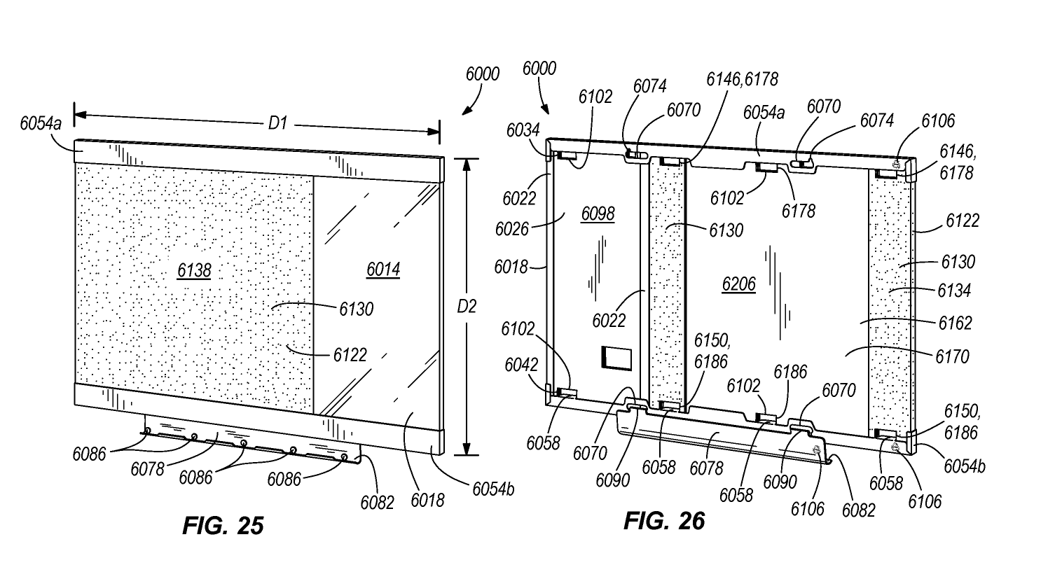

FIGS. 25-27 illustrate yet another construction of a display board assembly 6000 configured as a combination dry-erase board and bulletin board. The display board assembly 6000 includes components that are substantially similar to both of the display board assembly 10 of FIGS. 1-3 and the display board assembly 118 of FIGS. 7-9. Like components are labeled with like reference numerals, plus “6000.”

As shown in FIG. 25, the display board assembly 6000 is oriented such that its major dimension D1 is substantially horizontal with respect to the ground. As such, the abutting edge portions 6022, 6134 of the outer shells 6018, 6122 (see FIG. 26) define a substantially vertical separation line between the dry-erase surface 6014 on the outer shell 6018 and the bulletin board surface 6138 of the outer shell 6122 (see FIG. 25), and the outer shell 6018 and the outer shell 6122 are arranged in a side-by-side relationship. In the illustrated construction of the display board assembly 6000, about one-third of the value of the major dimension D1 of the display board assembly 6000 is comprised of the dry-erase surface 6014, and about two-thirds of the value of the major dimension D1 of the display board assembly 6000 is comprised of the bulletin board surface 6138. Alternatively, about two-thirds of the value of the major dimension D1 of the display board assembly 6000 may be comprised of the dry-erase surface 6014, and about one-third of the value of the major dimension D1 of the display board assembly 6000 may be comprised of the bulletin board surface 6138.

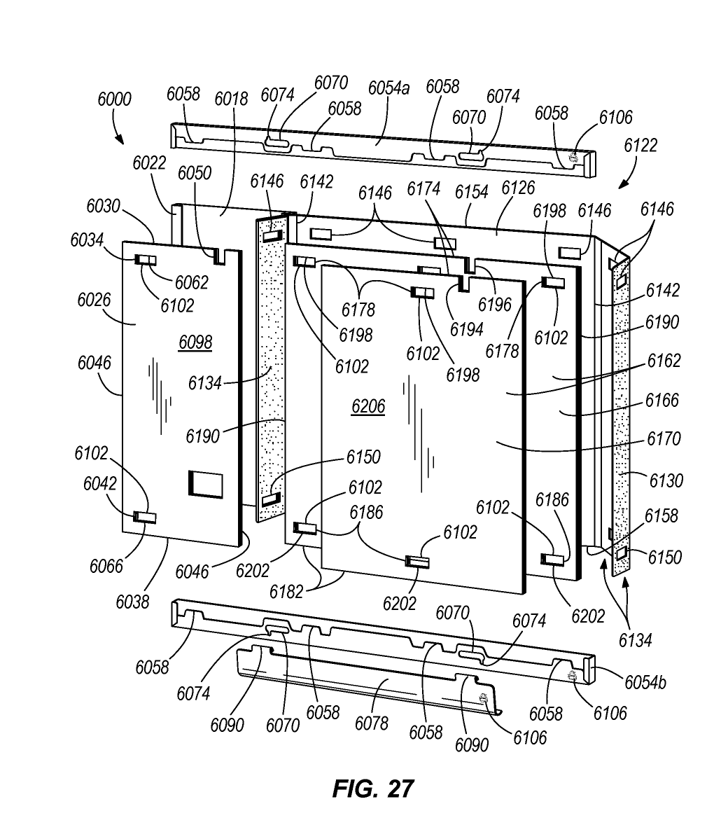

Because the display board assembly 6000 utilizes substantially similar frame members 6054a, 6054b as the display board assembly 2000 of FIGS. 13-15, the display board assembly 4000 of FIGS. 19-21, and the display board assembly 5000 of FIGS. 22-24, the cutouts 6034 adjacent the top edge 6030 of the backing 6026 and the cutouts 6178 adjacent the top edge 6174 of the backing 6162 are spaced along the major dimension D1 of the display board assembly 6000 to receive the four tabs 6058 of the top frame member 6054a (see FIGS. 26 and 27). Likewise, the cutouts 6042 adjacent the bottom edge 6038 of the backing 6026 and the cutouts 6186 adjacent the bottom edge 6182 of the backing 6162 are spaced along the major dimension D1 of the display board assembly 6000 to receive the four tabs 6058 of the bottom frame member 6054b.

Also, because the display board assembly 6000 utilizes substantially similar frame members 6054a, 6054b as the display board assembly 2000 of FIGS. 13-15, the display board assembly 4000 of FIGS. 19-21, and the display board assembly 5000 of FIGS. 22-24, the cutout 6050 positioned adjacent the top edge 6030 of the backing 6026 is substantially aligned with the notch 6074 in one of the slots 6070 in the top frame member 6054a, and the cutouts 6194, 6196 positioned adjacent the top edge 6174 of the backing 6162 are substantially aligned with the notch 6074 in the other of the slots 6070 in the top frame member 6054a to facilitate mounting of the display board assembly 6000.

The display board assembly 6000 may be disassembled in the same manner as described above with reference to the display board assembly 10 of FIGS. 1-3 and the display board assembly 118 of FIGS. 7-9 to allow each of the components of the display board assembly 6000 to be recycled. Although recycling instructions are not shown on the rear of the display board assembly 6000, recycling instructions similar to the instructions 94 on the display board assembly 10 of FIGS. 1-3 and the display board assembly 118 of FIGS. 7-9 may also be incorporated on the rear of the display board assembly 6000 of FIGS. 25-27.

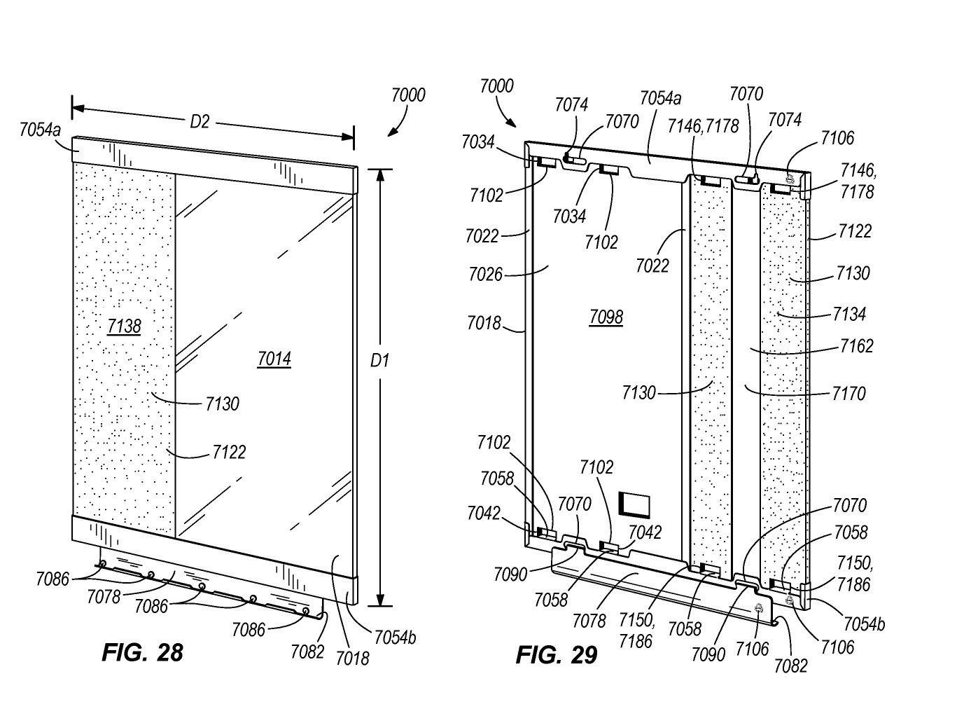

FIGS. 28-30 illustrate another construction of a display board assembly 7000 configured as a combination dry-erase board and bulletin board. The display board assembly 7000 includes components that are substantially similar to both of the display board assembly 10 of FIGS. 1-3 and the display board assembly 118 of FIGS. 7-9. Like components are labeled with like reference numerals, plus “7000.”

As shown in FIG. 28, the display board assembly 6000 is oriented such that its minor dimension D2 is substantially horizontal with respect to the ground. As such, the abutting edge portions 7022, 7134 of the outer shells 7018, 7122 (see FIG. 29) define a substantially vertical separation line between the dry-erase surface 7014 on the outer shell 7018 and the bulletin board surface 7138 of the outer shell 7122 (see FIG. 28), and outer shell 7018 and the outer shell 7122 are arranged in a side-by-side relationship. In the illustrated construction of the display board assembly 7000, about two-thirds of the value of the minor dimension D2 of the display board assembly 7000 is comprised of the dry-erase surface 7014, and about one-third of the value of the minor dimension D2 of the display board assembly 7000 is comprised of the bulletin board surface 7138. Alternatively, about one-third of the value of the minor dimension D2 of the display board assembly 7000 may be comprised of the dry-erase surface 7014, and about two-thirds of the value of the minor dimension D2 of the display board assembly 7000 may be comprised of the bulletin board surface 7138.

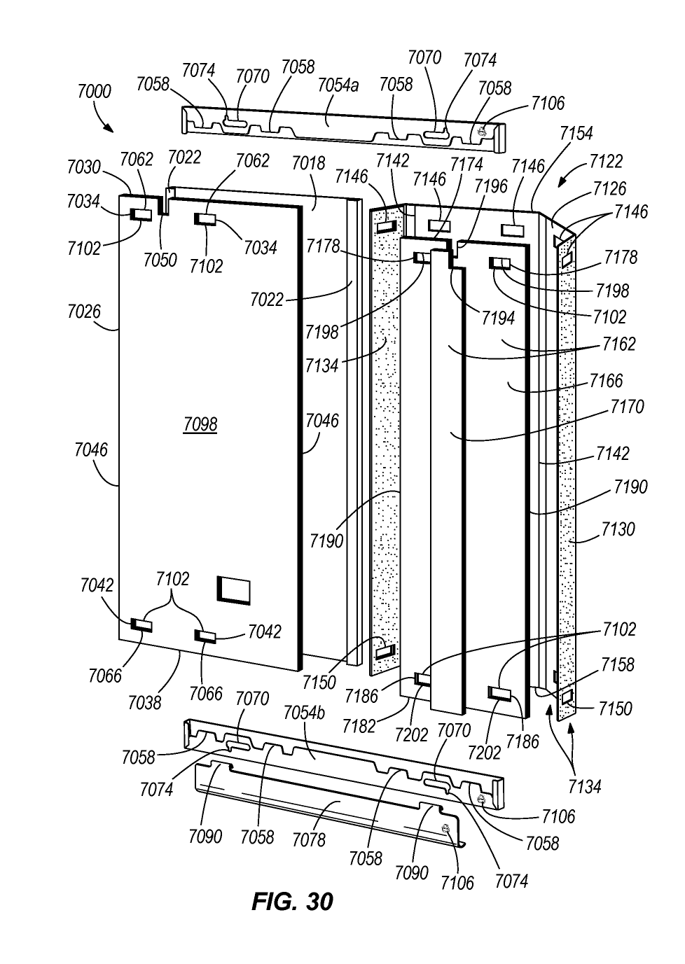

Because the display board assembly 7000 utilizes substantially similar frame members 7054a, 7054b as the display board assembly 1000 of FIGS. 10-12 and the display board assembly 3000 of FIGS. 16-18, the cutouts 7034 adjacent the top edge 7030 of the backing 7026 and the cutouts 7178 adjacent the top edge 7174 of the backing 7162 are spaced along the minor dimension D2 of the display board assembly 7000 to receive the four tabs 7058 of the top frame member 7054a (see FIGS. 29 and 30). Likewise, the cutouts 7042 adjacent the bottom edge 7038 of the backing 7026 and the cutouts 7186 adjacent the bottom edge 7182 of the backing 7162 are spaced along the minor dimension D2 of the display board assembly 7000 to receive the four tabs 7058 of the bottom frame member 7054b.

Also, because the display board assembly 7000 utilizes substantially similar frame members 7054a, 7054b as the display board assembly 1000 of FIGS. 10-12 and the display board assembly 3000 of FIGS. 16-18, the cutout 7050 positioned adjacent the top edge 7030 of the backing 7026 is substantially aligned with the notch 7074 in one of the slots 7070 in the top frame member 7054a, and the cutouts 7194, 7196 positioned adjacent the top edge 7174 of the backing 7162 are substantially aligned with the notch 7074 in the other of the slots 7070 in the top frame member 7054a to facilitate mounting of the display board assembly 7000.

The display board assembly 7000 may be disassembled in the same manner as described above with reference to the display board assembly 10 of FIGS. 1-3 and the display board assembly 118 of FIGS. 7-9 to allow each of the components of the display board assembly 7000 to be recycled. Although recycling instructions are not shown on the rear of the display board assembly 7000, recycling instructions similar to the instructions 94 on the display board assembly 10 of FIGS. 1-3 and the display board assembly 118 of FIGS. 7-9 may also be incorporated on the rear of the display board assembly 7000 of FIGS. 28-30.

Although not shown, the display board assemblies 5000, 6000, 7000 of FIGS. 22-24, FIGS. 25-27, and FIGS. 28-30, respectively, may include a calendar printed on the respective dry-erase surface 5014, 6014, 7014 in the same manner as the display board assembly 110 of FIGS. 4-6 to facilitate usage of the display board assemblies 5000, 6000, 7000 as a scheduler or planner. The display board assemblies 5000, 6000, 7000 may also include the magnetic strips 114 shown in FIG. 4 and described above.

Various features of the invention are set forth in the following claims.

What is claimed is:

1. A display board assembly comprising:
a substrate having a first edge and a second edge;
a non-fabric bulletin board sheet including
a first edge portion wrapped around the first edge of the substrate to at least partially cover the first edge of the substrate; and
a second edge portion wrapped around the second edge of the substrate to at least partially cover the second edge of the substrate.

2. The display board assembly of claim 1, wherein the first edge portion of the non-fabric bulletin board sheet has at least one fold line substantially parallel to the first edge of the substrate, and wherein the second edge portion has at least one fold line substantially parallel to the second edge of the substrate.

3. The display board assembly of claim 1, wherein the non-fabric bulletin board sheet includes a backing to which the non-fabric bulletin board sheet is attached.

4. The display board assembly of claim 3, wherein the backing is a corrugated material.

5. The display board assembly of claim 1, wherein the substrate includes a third edge and a fourth edge, wherein the display board assembly further includes
a first frame member positioned over the third edge of the substrate to at least partially secure the non-fabric bulletin board sheet to the substrate; and
a second frame member positioned over the fourth edge of the substrate to at least partially secure the non-fabric bulletin board sheet to the substrate.

6. The display board assembly of claim 5, further comprising a tray coupled to at least one of the first and second frame members.

7. The display board assembly of claim 6, wherein the tray includes
a surface configured to support a writing utensil; and
a hook extending from the support surface, the hook configured to receive a key ring.

8. The display board assembly of claim 1, wherein the non-fabric bulletin board sheet includes a cork sheet.

9. The display board assembly of claim 1, wherein the substrate is a first substrate, and wherein the display board assembly further comprises:
a second substrate having a first edge and a second edge;
a dry-erase sheet including
a first edge portion wrapped around the first edge of the second substrate to at least partially cover the first edge of the second substrate;
a second edge portion wrapped around the second edge of the second substrate to at least partially cover the second edge of the second substrate;
a first frame member coupling the first substrate and the non-fabric bulletin board sheet to the second substrate and the dry-erase sheet; and
a second frame member coupling the first substrate and the non-fabric bulletin board sheet to the second substrate and the dry-erase sheet.

10. The display board assembly of claim 9, wherein the first edge portion of the non-fabric bulletin board sheet is abutted with the second edge portion of the dry-erase sheet.

11. The display board assembly of claim 9, wherein the first and second frame members are substantially parallel to each other, and wherein the first and second frame members are substantially transverse to the first and second edge portions of the non-fabric bulletin board sheet and the first and second edge portions of the dry-erase sheet.

12. The display board assembly of claim 11, wherein the first and second frame members retain the non-fabric bulletin board sheet and the dry-erase sheet in a side-by-side relationship.

13. The display board assembly of claim 1, wherein the substrate includes a first surface and a second surface substantially parallel to the first surface, wherein the non-fabric bulletin board sheet overlies the first surface of the substrate, and wherein recycling instructions are printed on the second surface of the substrate.

14. A display board assembly comprising:
a substrate defining a first dimension and a second dimension substantially transverse to the first dimension, the substrate having a first edge and a second edge in the direction of the first dimension and a third edge and a fourth edge in the direction of the second dimension;
at least one of a dry-erase sheet and a bulletin board sheet, the at least one of the dry-erase sheet and bulletin board sheet including
a first edge portion wrapped around the first edge of the substrate to at least partially cover the substrate;
a second edge portion wrapped around the second edge of the substrate to at least partially cover the substrate;
a first frame member positioned over the third edge of the substrate to at least partially secure the one of the dry-erase sheet and bulletin board sheet to the substrate; and
a second frame member positioned over the fourth edge of the substrate to at least partially secure the one of the dry-erase sheet and the bulletin board sheet to the substrate.

15. The display board assembly of claim 14, wherein the first edge portion has at least one fold line substantially parallel to the first edge of the substrate, and wherein the second edge portion has at least one fold line substantially parallel to the second edge of the substrate.

16. The display board assembly of claim 14, wherein each of the first and second frame members includes a tab engaging the substrate.

17. The display board assembly of claim 14, wherein no fasteners are utilized to secure the first frame member to the one of the dry-erase sheet and the bulletin board sheet to the substrate, and wherein no fasteners are utilized to secure the second frame member to the one of the dry-erase sheet and the bulletin board sheet to the substrate.

18. The display board assembly of claim 14, wherein no additional frame members are utilized to cover the first edge portion of the one of the dry-erase sheet and the bulletin board sheet wrapped around the first edge of the substrate, and wherein no additional frame members are utilized to cover the second edge portion of the one of the dry-erase sheet and the bulletin board sheet wrapped around the second edge of the substrate.

19. The display board assembly of claim 14, further comprising a tray coupled to at least one of the first and second frame members.

20. The display board assembly of claim 19, wherein the tray includes
a surface configured to support a writing utensil; and
a hook extending from the support surface, the hook configured to receive a key ring.

21. The display board assembly of claim 14, wherein the bulletin board sheet includes a cork sheet.

22. The display board assembly of claim 14, wherein the substrate is a first substrate, wherein the at least one of the dry-erase sheet and the bulletin board sheet is the bulletin board sheet, and wherein the display board assembly further comprises:
a second substrate defining a first dimension and a second dimension substantially transverse to the first dimension, the second substrate having a first edge and a second edge in the direction of the first dimension of the second substrate and a third edge and a fourth edge in the direction of the second dimension of the second substrate;
a dry-erase sheet including
a first edge portion wrapped around the first edge of the second substrate to at least partially cover the second substrate;
a second edge portion wrapped around the second edge of the second substrate to at least partially cover the second substrate;
wherein the first frame member is positioned over the third edge of the second substrate to at least partially secure the dry-erase sheet to the second substrate, and wherein the second frame member is positioned over the fourth edge of the second substrate to at least partially secure the dry-erase sheet to the second substrate.

23. The display board assembly of claim 22, wherein the first edge portion of the non-fabric bulletin board sheet is abutted with the second edge portion of the dry-erase sheet.

24. The display board assembly of claim 22, wherein the first and second frame members retain the non-fabric bulletin board sheet and the dry-erase sheet in a side-by-side relationship.

25. A display board assembly comprising:
at least one substrate having
a first edge and a second edge;
a first cutout adjacent the first edge;
a second cutout adjacent the second edge;
one of a dry-erase sheet and a bulletin board sheet overlying the substrate;
a first frame member positioned over the first edge of the substrate and a portion of the one of the dry-erase sheet and bulletin board sheet, the first frame member having a tab engaging the first cutout; and
a second frame member positioned over the second edge of the substrate and a portion of the one of the dry-erase sheet and bulletin board sheet, the second frame member having a tab engaging the second cutout.
